(19) United States
(12) Patent Application Publication
(10) Pub. No.: US 2002/0070227 A1
(43) Pub. Date: Jun. 13, 2002

(54) PERSONAL PILL DISPENSING DEVICE

(76) Inventor: Terresa Ferruccio, Highlands, CA (US)

Correspondence Address: Richard W. Goldstein, 2071 Clove Road, Staten Island, NY, 10304, US

(21) Appl. No.: 09/735,047

(22) Filed: Dec. 13, 2000

(51) Int. Cl. G07F 11/00

(52) U.S. Cl. 221/15; 221/133

(57) ABSTRACT

A personal pill dispensing device including a housing having a top wall, a bottom wall, opposed side walls, a front wall, and a back wall. The housing has a hollow interior. The top wall has a plurality of rotating dispensing dials disposed therein in communication with the hollow interior. The dispensing dials each are defined by a plurality of apertures of varying diameters arranged in a circular configuration. The apertures are alignable with an outlet chute disposed within the hollow interior. The housing includes a main chute disposed within the hollow interior. The main chute is disposed below the outlet chutes to direct pills into a collection area. A collection tray is slidably disposed within the front wall in communication with the collection area. An activation button is disposed within the front wall.

### BACKGROUND OF THE INVENTION

The present invention relates to a personal pill dispensing device and more particularly pertains to holding a plurality of pills for being timely dispensed and monitored.

Many people today take vitamins and medication on a daily basis. Some of these people take multiple pills on a daily basis and often become confused when trying to remember whether or not they have take a particular pill for that day. This often causes the person to count the remaining pills in a bottle to figure out if they have taken a previously scheduled dose. This method is confusing and often results in the person taking an extra, or one less dose than is required. What is needed is a device that will help a person safely monitor the pills and medication that they are taking so that they can be assured that they are tasking the proper amounts of medication during, and throughout, each day.

The present invention attempts to solve the abovementioned problem by providing a device that serves as a pill, day, and date counter that monitors the dispensing of medication.

The use of pill dispensers is known in the prior art. More specifically, pill dispensers heretofore devised and utilized for the purpose of dispensing a quantity of pills are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,013,192 to Pillon discloses a pill counter, for use by a pharmacist, to dispense a quantity of pills into a bottle. U.S. Pat. No. Des. 343,859 to Fisher discloses the ornamental design for a combination pill reminder calendar and message board.

While these devices fulfill their respective, particular objective and requirements, the aforementioned patents do not describe a personal pill dispensing device for holding a plurality of pills for being timely dispensed and monitored.

In this respect, the personal pill dispensing device according to the present invention substantially departs from the conventional concepts and designs of the prior art, and in doing if so provides an apparatus primarily developed for the purpose of holding a plurality of pills for being timely dispensed and monitored.

Therefore, it can be appreciated that there exists a continuing need for a new and improved personal pill dispensing device which can be used for holding a plurality of pills for being timely dispensed and monitored. In this regard, the present invention substantially fulfills this need.

### SUMMARY OF THE INVENTION

In the view of the foregoing disadvantages inherent in the known types of pill dispensers now present in the prior art, the present invention provides an improved personal pill dispensing device. As such, the general purpose of the present invention, which will be described subsequently in greater detail, is to provide a new and improved personal pill dispensing device which has all the advantages of the prior art and none of the disadvantages.

To attain this, the present invention essentially comprises a housing having a top wall, a bottom wall, opposed side walls, a front wall, and a back wall. The housing has a hollow interior. The top wall has a plurality of rotating dispensing dials disposed therein in communication with the hollow interior. The dispensing dials have a circular collar extending upwardly therefrom for receiving and coupling with an inverted pill bottle. The dispensing dials each are defined by a plurality of apertures of varying diameters arranged in a circular configuration. The apertures are alignable with an outlet chute disposed within the hollow interior. The housing includes a main chute disposed within the hollow interior. The main chute is disposed below the outlet chutes to direct pills into a collection area. A collection tray is slidably disposed within the front wall in communication with the collection area. An activation button is disposed within the front wall. A plurality of counters are disposed within the front wall of the housing. The plurality of counters are in communication with the plurality of dispensing dials. The plurality of counters include a date counter, a day counter, and a pill counter.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved personal pill dispensing device which has all the advantages of the prior art pill dispensers and none of the disadvantages.

It is another object of the present invention to provide a new and improved personal pill dispensing device which may be easily and efficiently manufactured and marketed.

It is a further object of the present invention to provide a new and improved personal pill dispensing device which is of durable and reliable construction.

An even further object of the present invention is to provide a new and improved personal pill dispensing device which is susceptible of a low cost of manufacture with regard to both materials and labor, and which accordingly is then susceptible of low prices of sale to the consuming public, thereby making such a personal pill dispensing device economically available to the buying public.

Even still another object of the present invention is to provide a new and improved personal pill dispensing device for holding a plurality of pills for being timely dispensed and monitored.

Lastly, it is an object of the present invention to provide a new and improved personal pill dispensing device including a housing having a top wall, a bottom wall, opposed side walls, a front wall, and a back wall. The housing has a hollow interior. The top wall has a plurality of rotating dispensing dials disposed therein in communication with the hollow interior. The dispensing dials each are defined by a plurality of apertures of varying diameters arranged in a circular configuration. The apertures are alignable with an outlet chute disposed within the hollow interior. The housing includes a main chute disposed within the hollow interior. The main chute is disposed below the outlet chutes to direct pills into a collection area. A collection tray is slidably disposed within the front wall in communication with the collection area. An activation button is disposed within the front wall.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the personal pill dispensing device constructed in accordance with the principles of the present invention.

FIG. 2 is a cross-sectional front view of the present invention.

FIG. 3 is a partial top plan view of the present invention illustrating the dispensing dial thereof.

The same reference numerals refer to the same parts through the various figures.

### DESCRIPTION OF THE PREFERRED EMBODIMENT

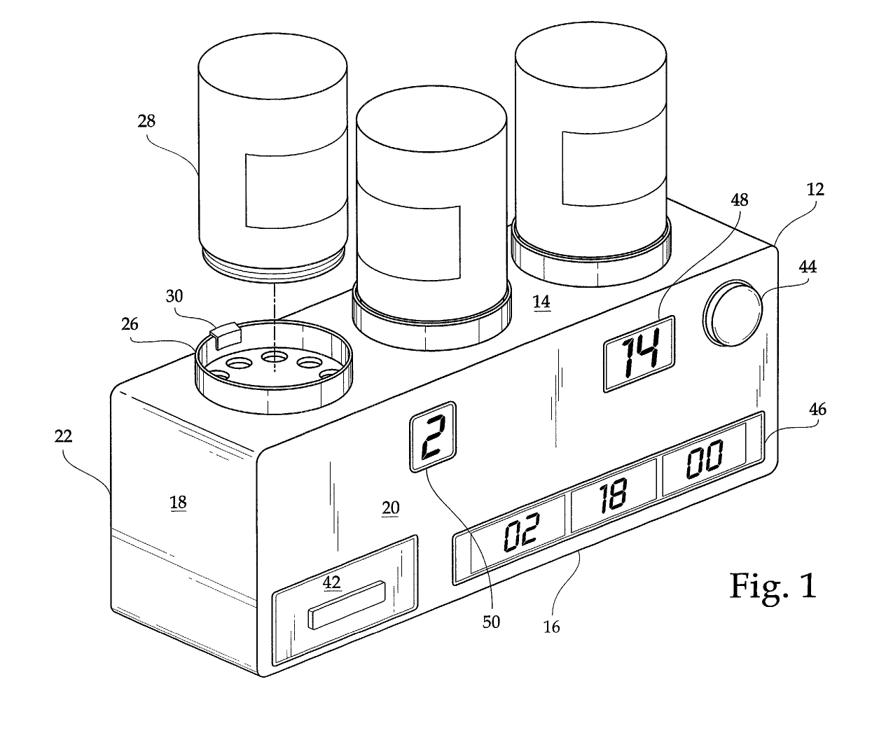

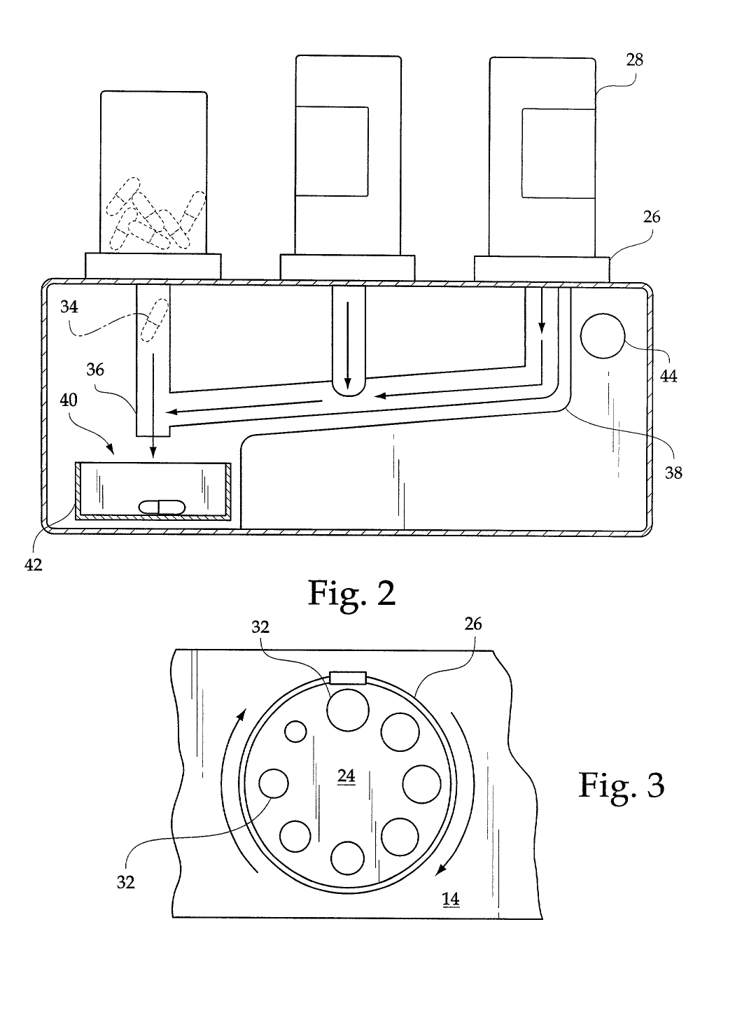

With reference now to the drawings, and in particular, to FIGS. 1 through 3 thereof, the preferred embodiment of the new and improved personal pill dispensing device embodying the principles and concepts of the present invention and generally designated by the reference number 10 will be described.

Specifically, it will be noted in the various figures that the device relates to a personal pill dispensing device for holding a plurality of pills for being timely dispensed and monitored. In its broadest context, the device consists of a housing and a plurality of counters. Such components are individually configured and correlated with respect to each other so as to attain the desired objective.

The housing 12 has a top wall 14, a bottom wall 16, opposed side walls 18, a front wall 20, and a back wall 22. The housing 12 has a hollow interior. The top wall 14 has a plurality of rotating dispensing dials 24 disposed therein in communication with the hollow interior. The dispensing dials 24 have a circular collar 26 extending upwardly therefrom for receiving and coupling with an inverted pill bottle 28. Additionally, the collar 26 will be provided with a clamp 30 to prevent the inadvertent removal of the pill bottle 28. The dispensing dials 24 each are defined by a plurality of apertures 32 of varying diameters arranged in a circular configuration. In use, the dials 24 will rotate until a proper aperture is reached that will allow a pill 34 of a particular size to go through. The apertures are alignable with an outlet chute 36 disposed within the hollow interior. The housing 12 includes a main chute 38 disposed within the hollow interior. The main chute 38 is disposed below the outlet chutes 36 to direct pills 34 into a collection area 40. A collection tray 42 is slidably disposed within the front wall 20 in communication with the collection area 40. An activation button 44 is disposed within the front wall 20. The activation button 44 will be pressed in order to cause the dials 24 to rotate in order to dispense the pills 34. Once the activation button 44 has been pressed, the pills 34 will accumulate within the collection tray 42 which will subsequently slide out of the housing 12 for the person to remove and ingest.

The plurality of counters are disposed within the front wall 20 of the housing 12. The plurality of counters are in communication with the plurality of dispensing dials 24. The plurality of counters include a date counter 46, a day counter 48, and a pill counter 50. The date counter 46 keeps track of calendar days and displays them for informational purposes. The day counter 48 keeps track of the number of days a particular prescription is being used. The pill counter 50 tracks the number of pills that have been taken during a single day.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A personal pill dispensing device for holding a plurality of pills for being timely dispensed and monitored comprising, in combination:
a housing having a top wall, a bottom wall, opposed side walls, a front wall, and a back wall, the housing having a hollow interior, the top wall having a plurality of rotating dispensing dials disposed therein in communication with the hollow interior, the dispensing dials having a circular collar extending upwardly therefrom for receiving and coupling with an inverted pill bottle, the dispensing dials each being defined by a plurality of apertures of varying diameters arranged in a circular configuration, the apertures being alignable with an outlet chute disposed within the hollow interior, the housing including a main chute disposed within the hollow interior, the main chute being disposed below the outlet chutes to direct pills into a collection area, a collection tray slidably disposed within the front wall in communication with the collection area, an activation button disposed within the front wall; and
a plurality of counters disposed within the front wall of the housing, the plurality of counters being in communication with the plurality of dispensing dials, the plurality of counters including a date counter, a day counter, and a pill counter.

2. A personal pill dispensing device for holding a plurality of pills for being timely dispensed and monitored comprising, in combination:
a housing having a top wall, a bottom wall, opposed side walls, a front wall, and a back wall, the housing having a hollow interior, the top wall having a plurality of rotating dispensing dials disposed therein in communication with the hollow interior, the dispensing dials each being defined by a plurality of apertures of varying diameters arranged in a circular configuration, the apertures being alignable with an outlet chute disposed within the hollow interior, the housing including a main chute disposed within the hollow interior, the main chute being disposed below the outlet chutes to direct pills into a collection area, a collection tray slidably disposed within the front wall in communication with the collection area, an activation button disposed within the front wall.

3. The personal pill dispensing device as set forth in claim 2, wherein the dispensing dials having a circular collar extending upwardly therefrom for receiving and coupling with an inverted pill bottle.

4. The personal pill dispensing device as set forth in claim 2, and further including a plurality of counters disposed within the front wall of the housing, the plurality of counters are in communication with the plurality of dispensing dials.

5. The personal pill dispensing device as set forth in claim 4, wherein the plurality of counters include a date counter, a day counter, and a pill counter.
